(19) United States
(12) Patent Application Publication
(10) Pub. No.: US 2005/0128485 A1
(43) Pub. Date: Jun. 16, 2005

(54) Portable device for total gossypol measurement

(76) Inventors: Madan Lal Singla, Chandigarh (IN); Mewa Singh, Chandigarh (IN); Prasant Kumar Mahapatra, Chandigarh (IN)

Correspondence Address: Alfred D. Lobo & Co., L.P.A., 933 The Leader Building, 526 Superior Avenue E, Cleveland, OH, 44114-1902, US

(21) Appl. No.: 10/735,555

(22) Filed: Dec. 12, 2003

(51) Int. Cl. G01N 21/59

(52) U.S. Cl. 356/432

(57) ABSTRACT

The measurement of gossypol in cotton seed products using conventional methods namely spectrophotmetric, NMR methods, chemiluminsecent method, gas-liquid chromatography polarography, thin layer chromatography and paper chromatography are tedious, time-consuming, high cost and needs calibrated systems. In the present invention, a low cost and portable system is devised and the concentration of total gossypol is directly displayed on LCD in mgl⁻¹ or ppm from the test solution and no standard solution is required to make calibration curve for measuring the absorbance.

### FIELD OF THE INVENTION

The present invention relates to a device useful for the determination of Gossypol in Cottonseed deoiled cake, cottonseed and compounds having gossypol after development of green colour complex with Iron [Fe (III)].

### BACKGROUND AND PRIOR ART REFERENCES

Cottonseed products in the forms of oils and meal are widely used for human and animal food. However, the utilization of cottonseed products in human and its nutrition is limited by the presence of polyphenolic compounds, Gossypol. The toxicity of gossypol also limits to own application in many areas.

Gossypol is a biologically active terpenoid substance present in discrete glands in many parts of the cotton plant, including the seed kernel. Much of the gossypol is found naturally in the glands or chemically bound to the protein portion of the seed. The pigment is a toxic compound in its free form and accumulates in body tissues.

Cottonseed is processed into oils and meals for both animal and human consumption. Toxicity of gossypol is attributed to free gossypol, as opposed to bound gossypol. Food and Drug Administration (FDA) and the United Nations Protein Advisory Group established limits for gossypol content in human foodstuffs.

Common symptom associated with gossypol toxicity include reduced feed in take, weight loss, hyper prothrombinemia, diarrhea, erythrocyte fragility and associated reductions in blood hemoglobin values, edematous fluid accumulation in heart & and lung cavities which degenerate changes in liver and spleen. Gossypol exhibits both phenolic as well as aldehydic properties.

Several methods have been used/reported for the determination of gossypol in a variety of samples. Methods used for analysis of gossypol includes spectrophotometric method (American Oil Chemist Society” Official and Tentative Methods”, American Oil Chemists Society: Champaign, Ill., 1978; Tentative Method Ba 8-58; Crouch, Floyd W; Bryant Melton F. Anal. Chem. 1982, 54, 242-246; Pons, W. A.; Guthrie, J. D. J. Am. Oil Chem. Soc. 1949, 26, 671-676, Pons, W. A.; Hoffpauir C. L.; O'Connor, R. T. J. Am. Oil Chem. Soc 1951, 28, 8-12.) for the determination of gossypol using available spectrophotometers. In these spectrophotometric methods, which are either in UV or Visible range, needs test instrument, standard test samples are needed to make calibration curve by plotting known concentration vs. absorbance/transmittance values. For analysis of unknown samples after preparing the test samples, absorbance/transmittance values are recorded and put in the already plotted curve to get its concentration. The reference Atnafseged Admasu, B. S. Chandravanshi; Analytical Chem. Vol. 56, NO. 1 January 1984. 30-32 is again spectrophotometric method for the determination of total gossypol in cottonseeds and cottonseed meals using Beckman model 26 UV-Visible spectrophotometer with 1 cm path length quartz tube and absorbance values are measured. In the present invention we have developed a device where concentration of gossypol is directly displayed on LCD. No calibration curve or absorbance values are needed for the calibration of the system.

The references Waiss, A. C.; Chan, B. G.; Benson, M,; Lukefahr, M. J. J. Assoc. off. Anal Chem. 1978, 61, 146-149; Aver'yanov, A. A.; Merzlyak, M. N. Rubin, B. A. Biokhmiya (Moscow) 1978, 43 1594-1601. Chem. Abstr. 1978, 89, 211079h; Raju P. K; Cater, C. J. Am. Oil Chem. Soc. 1967, 44, 465-466; Markman, A. L.; Rzhekhin, V. P. “Gossypol and its Derivatives”; Isreal program for Scientific Translations: Jerusalem, 1968; Chapter8 are other instrumental techniques, which involve Nuclear Magnetic Resonance (NMR), Chemiluminescent, Gas liquid chromatography, Polarography & thin layer chromatography. These methods are costly involves complex systems, analysis & interpretation of results are quite tedious are not of common use where as the present system is dedicated for the determination of the gossypol. Polarography involves the system for measuring polarographic data along with dropping mercury electrode, calomel electrode, supporting electrolyte, standard solutions, interpretation of results etc that is quite cumbersome and analysis time is quite long. Chromatographic techniques involve costly instruments, detectors, columns, and require trained persons. Reference Elsimar Metzkar Coutinho Elsevier Science Inc. Contraception Vol. 65 Issue 4 April 2002, Pages 259-263 is about contraceptive effects of gossypol. Reference Kyeong-Jun Lee and Konrad Dabrowski Journal of Chromatography B Vol 779, Issue 2, 5 Nov. 2002, pages 313-319 involves the analysis of gossypol from fisheries by chromatographic techniques.

Most of system methods are tedious, time consuming, high cost, needs a calibrated system curves. The novelty of the present invention is that concentration of total gossypol is directly displayed on LCD in mg l⁻¹ or ppm from the test solution and no calibration curve is needed for measuring the absorbance of solutions containing known amount of gossypol.

The background of the art clearly shows the drawbacks in the prior arts and the inventors have studied comprehensively and identified the limitations involved in the above-mentioned processes. In an attempt to obviate such drawbacks, the inventors have devised an apparatus for directly displaying on LCD in mgl⁻¹ or ppm from the test solution and no calibration curve is needed. Although, individually the function of the components involved in the apparatus are known but the assembling and functional inter-relationship to achieve a desired result have been obtained for the first time. Hence, the inventive and novel features of the invention have been marked out.

### OBJECTS OF THE INVENTION

The main objective of the present invention is to provide a portable system for the measurement of total gossypol in cottonseeds, cottonseed-deoiled cake, cottonseed oil and in gossypol compound after green colour development.

The other objective of the present invention is to provide a portable device useful for the determination of gossypol in deoiled cake, cottonseed in terms of milligram litre ⁻¹(mg l⁻¹) or ppm with range varying from 5 ppm to 75 ppm.

Another Objective of the present invention is to provide direct display of total concentration of total gossypol in mg l⁻¹ on 3½ digit LCD.

Yet another objective of the present invention is that the system is operated using LED source of 635 nm (50 milliwatt) thus consuming lower power eliminating the use of tungsten lamp, filters.

Another object of invention is to eliminate the cumbersome optics in spectrophotometer.

Another objective is that no calibration curve is to stored in memory for display of actual values of gossypol.

Another object of the present invention is that 100% transmittance level in distilled water is adjusted from the intensity of the light.

Another objective of the present invention is that sample holder is especially designed to hold Borosil circular Glass cuvettee of 17 mm dia with volume capacity of 6 ml.

Still another Objective of the present invention is that the system operates at ±6 V (Battery operated).

### SUMMARY OF THE INVENTION

The device of the present invention is a useful as a prototype instrument to measure gossypol concentration in deoiled cake/cottonseed/cottonseed oil. The instrument of the present invention is used on the Lambert Beer's Law.

### BRIEF DESCRIPTION OF THE ACCOMPANYING FIGURES

FIG. 1: Projected views of the cuvette sample holder

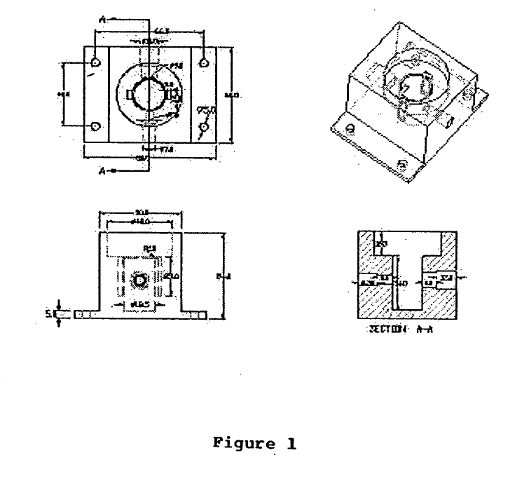

FIG. 2: represents the block diagram of the device

FIG. 3: represents the block diagram of the sample holder

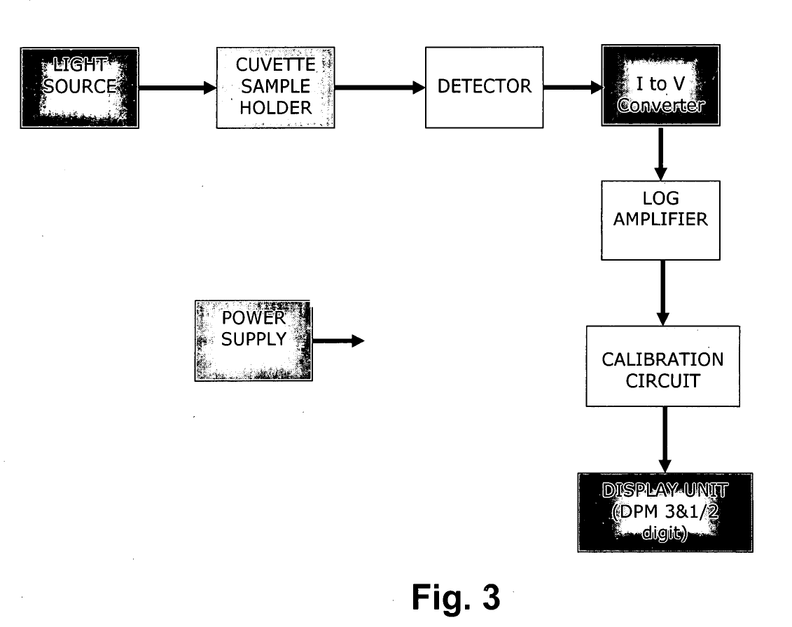

### DETAILED DESCRIPTION OF THE INVENTION

The device of the present invention comprises of following sub-system. In FIG. (I) of the drawing accompanying this specifications the Block diagram of the device of the present invention is shown.
(1) Light source LED of 5 mm having intensity of 125 mcd, view angle of 24°, peak wavelength of 635 nm and power dissipation of 50 mW.

The intensity of light from LED has been adjusted with a potentiometer (multiturn) in order to get 100% transmittance of light through distilled water in a cuvettee.
(2) is the sample holder
(3) is the photo detector
(4) Electronic circuit
(5) Concentration display
(6) Power source
(7) Computer

According to the present invention provides a useful device for the determination of gossypol in cottonseed, cottonseed meals in terms of milligram/liter or parts per million (ppm).

In an embodiment of the present invention the device used 5 mm size light emitting diode (LED) size of 635 nm with a adjustable potentiometer (multiturn) in order to get 100% transmittance or 0% absorbance of light through distilled water in the glass cuvettee of 17 mm path length.

In another embodiment of the present invention, the cuvettee holder is made up from aluminium alloy which has been blackened. The cuvettee holder has two sub-system tilted at opposite ends, one hold LED and other hold the detector. The cuvettee used is made up from Borosil glass with dia 17 mm, height is 5 cm and capacity of 6 ml with screw capped.

In another embodiment of the present invention a photo-detector BPW 21 having package of TO 5, effective area of detection of 5.9 mm diameter wavelength range of 460-750 nm and sensitivity of 7 nA/lux is used to detect the transmitted/absorbed light through the test solution.

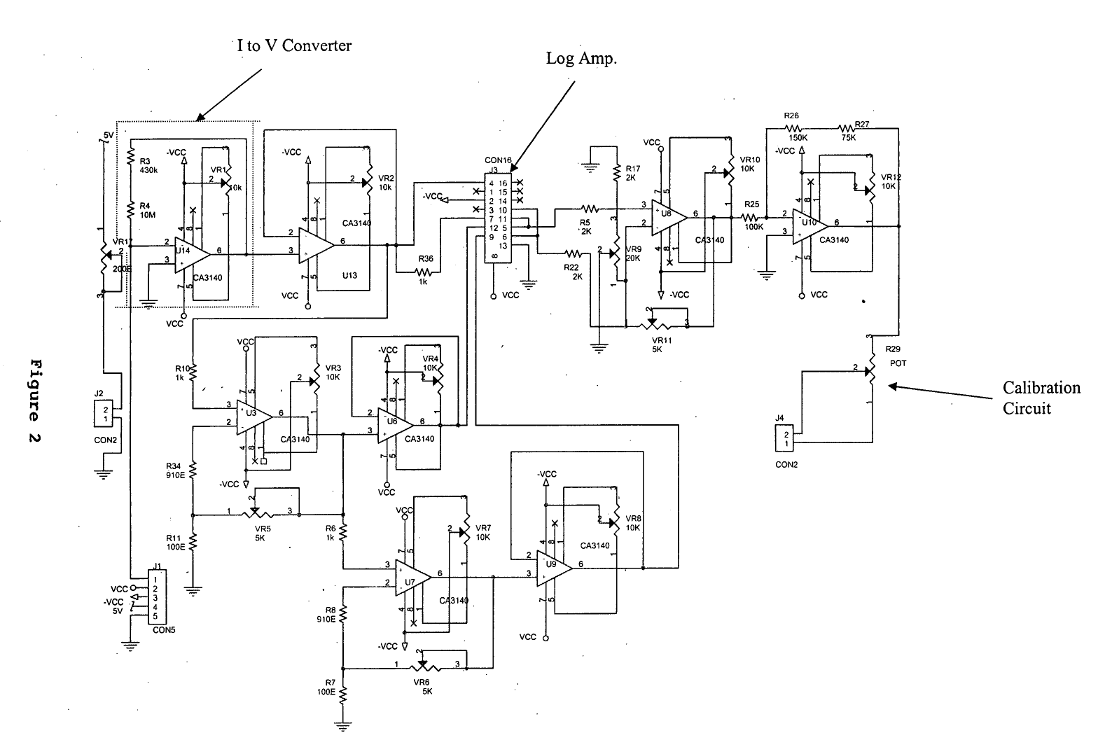

In another embodiment of the present invention, the detected light signal by the photo detector is converted to voltage using a current to voltage converter. The said current is proportional to the light signal detected. The output voltage of the IN converter is given by the potential difference between the resistance R3 and R4 as shown in FIG. 2.

In another embodiment of the present invention, the log amplifier is TL 441 IC.

In another embodiment of the present invention, voltage output after, log amplification digit has been calibrated in terms of gossypol concentration in test solution. This is basically a 10K POT as shown in FIG. We set this POT accordingly when we keep the known standard sample so that when we keep the unknown sample in cuvette holder it gives the exact reading in ppm, which is displayed in Digital Panel Meter (DPM).

In other embodiment the concentration results has been displaced on 3 and ½ digit LCD.

In other embodiment, the concentration results have been displayed on computer through CC⁺ large.

In another embodiment of the invention, VisiDAQ software for data acquisition & calculation after ADAM acquisition Module whose input is analog voltage derived from I-V converter & output is in digital form, which is connected to serial port of PC.

VisiDAQ is data acquisition and control application software and also an application builder for all kinds of automation. The script designer is a text editor with some convenient features for editing script code. The script source will be compiled into p-code after editing so it won't need to be compiled again at run-time. The syntax of the Basic Script is compatible with Microsoft VBA (Visual Basic for Application in Excel, Word, Access, etc.) and Microsoft Visual Basic. It is possible to take a Visual Basic source code and compile and execute it under Basic Script without changing a word if only common functions are used. The two development environments are very similar. In the source code design stage it features cut, copy and paste functions.

Task Designer uses a dataflow-programming model that frees user from the linear architecture of text-based languages. To create a process monitoring and control application, user construct the block diagram without worrying about the many syntactical details of conventional programming. Simply select objects (icons) from the Functions menu and connect them with wires to pass data from one block to the next.

Task Designer allows editing of multiple tasks at the same time. Each task is contained in a task window and has it's own properties such as scan rate, start/stop method, etc. One strategy file is used to store all scan tasks that are related to a control strategy. For simple strategy with only one task, it runs the same way as before. But for strategies that have more than one scan task, a top-level main script is required to manage the execution of all scan tasks.

A large complicated task can be broken into several smaller, simpler tasks. This not only simplifies the editing job, but also increases the performance at run-time, as fewer blocks need to be processed at each scan.

The Virtual Tag is a powerful feature that provides the ability to let developer to create customized tag in Task resigner without using User Defined DLL. The virtual tag is created by Task Designer and stored in data center as other built-in blocks. The virtual tags are global available to all tasks, so you can use virtual tags to share data among multiple tasks.

Data collection function creates database files for each defined TAG point at a user-specified time. Data collection function is designed for report generation. The shortest time interval for data collection from a given TAG point is 10 minutes. High-speed data collection is accomplished through other trend data collection functions. The invention is described in detail in the following examples given below which are provided to illustrate the invention and therefore should not be considered to limit the scope of the present invention.

### EXAMPLE—1

20 mg of pure gossypol compound was dissolved in 2 ml of glacial acetic acid and its volume was made to 100 ml with hexane isopropyl alcohol mixture. This solution corresponds to 200 ppm of gossypol. The colour was developed from this gossypol solution, using complexing agent of 3 amino propanol, dimethyl formamide and ferric nitrate (Anal Chemistry 1984, 56, 30-32, Ref. 5) mixture with suitable dilution to 25 ml which corresponds to 5, 10, 20, 30, 40, 60, 70 ppm. The results found to be 5±0.2, 10±0.3, 20±0.5, 30±0.5, 40±1.0, 60±0.8, 70±1.0.

### EXAMPLE—2

In other experiment 0.5 g of deoiled cake was taken in flask and added 10 ml of complexing agent as in example—I. The volume was made to 50 ml with hexane isopropyl alcohol mixture Colour was development from 2 ml, 5 ml and 10 ml of aliquot. The results were found on the development system as were 4 ppm, 9.8 ppm, 19.8 ppm. These results were compared with standard spectrophotometer by measuring absorbance values and calculated to be 4.3, 9.8 and 20.0 ppm.

### EXAMPLES—3

In other experiment 0.5 gm crushed cottonseed was digested in 10 ml of complexing agent and gossypol was extracted. The colour was developed and level of gossypol was measured found to be 20 ppm, which 1% of the total gossypol present.

### ADVANTAGES

The main advantage of the present invention:
It is Low cost and portable system
The sample holder is especially designed to hold glass cuvettee of 17 mm dia
The concentration of gossypol is directly displayed in ppm level after the colour development
No standard solution is required to make calibration curve.

1. A direct display portable device for measurement of gossypol concentration after colour development, said apparatus comprising:
a) a light source for emitting light of specific wavelength,
b) a means to control intensity of light from the light source,
c) a glass cuvettee for holding the test sample through which the light is passed,
d) a cuvette sample holder for holding the glass cuvettee,
e) a photo detector for detecting the light transmitted by test sample,
f) a means to convert the output current signal from the photo detector to voltage,
g) a log amplifier for amplifying the output signal of the converter,
h) a calibration circuit enabling display on a display unit, and
i) a power supply for supplying power to different components of the device.

2. The device as claimed in claim 1, wherein gossypol is selected from the group consisting of deoiled cake, cottonseed and cottonseed oil.

3. The device as claimed in claim 1, wherein the determination of the concentration of the gossypol concentration is in milligram/litre and parts per million (ppm) in the display unit of atleast 3½ digit display.

4. The device as claimed in claim 1, wherein the light source is an LED of 5 mm having intensity of 125 mcd, view angle of 24°, peak wavelength of 635 nm and power dissipation of 50 mW.

5. The device as claimed in claim 1, wherein the means used to control the intensity of light from LED is a multiturn potentiometer to get 100% transmittance (0% absorbance) of light through distilled water in the cuvette.

6. The device as claimed in claim 1, wherein the cuvettee used is made up from Borosil glass.

7. The device as claimed in claim 1, wherein path length of the glass cuvettee is of 17 mm.

8. The device as claimed in claim 1, wherein the cuvettee used is screw capped having a diameter of 17 mm, height of 5 cm and capacity of 6 ml.

9. The device as claimed in claim 1, wherein cuvettee holder is made up from aluminium alloy, which is blackened.

10. The device as claimed in claim 1, wherein the photo detector BPW 21 having package of TO 5, effective area of detection of 5.9 mm diameter wavelength range of 460-750 nm and sensitivity of 7 nA/lux is used to detect the transmitted/absorbed light through the test solution.

11. The device as claimed in claim 1, wherein the current to voltage converter produces voltage which is directly proportional to current flowing through the converter, which inturn is proportional to the light intensity falling on the detector.

12. The device as claimed in claim 1, wherein the means to convert the current signal to voltage signal is a current/voltage converter.

13. The device as claimed in claim 1, wherein the log amplifier is TL 441 IC.

14. The device as claimed in claim 1, wherein the calibration circuit is a 10 K POT and after log amplification, voltage output is calibrated in terms of gossypol concentration in the test solution.

15. The device as claimed in claim 1, wherein the power supply is a 6-Volt battery for the log amplifier, photo detector and other integrated chips and a 9-Volt supply for the display unit.

16. The device as claimed in claim 1, wherein the results are displayed on the display unit.

17. The device as claimed in claim 1, wherein the results are displayed on computer through CC⁺ large.

18. The device as claimed in claim 1, wherein a software VISIDAQ is used for data acquisition, calculation and control application.

19. The device as claimed in claim 1, wherein the present device is based on Lambert Beer's Law.

20. The device as claimed in claim 1 is low cost, portable, rugged and measures gossypol in the range of ±2% error.
